(19) United States
(12) Patent Application Publication
(10) Pub. No.: US 2011/0299361 A1
(43) Pub. Date: Dec. 8, 2011

(54) APPARATUS AND METHOD FOR IMAGING SUBSURFACE STRUCTURE

(76) Inventor: Changsoo Shin, Seoul (KR)

(21) Appl. No.: 13/201,550

(22) PCT Filed: Feb. 17, 2010
(86) PCT No.: PCT/KR10/00992

§ 371 Date: Aug. 15, 2011

Related U.S. Application Data
(60) Provisional application No. 61/202,308, filed on Feb. 17, 2009.

(51) Int. Cl. G01V 1/38; G01V 1/28

(52) U.S. Cl. 367/21; 367/73

(57) ABSTRACT

The present invention relates to an imaging technique for modeling a subsurface structure through waveform inversion in the Laplace domain. According to the present invention, a source equivalent to the real source is calculated. The equivalent source is at least one source arranged on a virtual grid of the area to be measured, and the virtual grid has a large size which cannot be employed as the location of the real source in conventional techniques. The equivalent source has a vector obtained by multiplying an analytical solution vector and an impedance matrix of a Laplace domain wave equation, wherein said analytical solution vector is obtained from the analytical solution of a Laplace domain wave equation in a homogeneous half space by the real source.

### BACKGROUND

1. Field

The following description relates to subsurface structure imaging, and more particularly, to an imaging technique for modeling a subsurface structure through waveform inversion in the Laplace domain.

2. Description of the Related Art

to A technique for imaging a subsurface structure through wave equation modeling in the Laplace domain is disclosed in Korea Patent Application No. 10-2008-0025876 entitled “An apparatus for imaging a subsurface structure using waveform inversion in the Laplace domain and methods” thereof, which is a prior application filed by the present applicant. The technique calculates modeling parameters for a subsurface structure by performing Laplace-domain waveform inversion on seismic signals acquired by receivers arranged on an area to be measured. The modeling parameters are obtained through an iterative method. First, a subsurface structure model is estimated approximately using initial modeling parameters set, and then signals that can be acquired by receivers when inputs from sources are applied to the estimated subsurface structure model, that is, modeling data is calculated. Then, the modeling parameters are updated by reducing errors between the modeling data and seismic signals measured by the receivers. The process is repeated using the updated modeling parameters. Thereafter, when the errors between the modeling data and the seismic signals are reduced below a predetermined value, the modeling parameters are adopted as imaging data for the corresponding subsurface structure. The modeling parameters may be velocity or density values, etc. of the subsurface medium, and a subsurface imaging apparatus represents the modeling parameters as a color image.

The algorithm for wave inversion in the Laplace domain has excellent dispersion characteristics, and accordingly can use a large grid size of about 80-200 m. As the grid size increases m times, the calculation amount by the iterative method decreases by m⁴. However, using such a large grid (a coarse grid) is actually impossible due to the Dirichlet boundary condition. Since a free surface is modeled with many types of boundary conditions such as the Neumann boundary condition in elastic wave equation and the Dirichlet boundary condition in acoustic wave equation, a source needs to be located one or several grids away from the boundary of the surface. Accordingly, in order to use, for example, a grid with the size of 100 m, a source has to be at the depth of 100 m or more away from the surface of the water. However, since air guns, actual sources that are generally used in seismic marine survey, are located in the range of 5-20 m (generally, 10 m or less) away from the surface of the water, the source problem makes it actually impossible to achieve the advantage of using a large grid size in the technology is of imaging the subsurface structure by modeling a wave equation in the Laplace domain.

### SUMMARY

The following description relates to a technique of allowing use of a large grid size in imaging a subsurface structure by modeling a wave equation in the Laplace domain.

The following description also relates to a technique of allowing use of a large grid size with a relatively small amount of calculation in imaging a subsurface structure by modeling a wave equation in the Laplace domain.

In one aspect, a source equivalent to a real source is calculated. The equivalent source is at least one source arranged on a virtual grid of an area to be measured, and the virtual grid has a large size that could not be employed as the location of a real source in conventional techniques.

In another aspect, a vector of the equivalent source is obtained by multiplying an analytical solution vector by an impedance matrix of a Laplace-domain wave equation, wherein the analytical solution vector is obtained from an analytical solution of a Laplace-domain wave equation in a homogeneous half space by the real source.

Therefore, since a large grid is adopted by using, instead of a real source, an equivalent source that is at least one source located at a coarse-grid point, the amount of calculation for imaging a subsurface structure by modeling a wave equation in the Laplace domain can be significantly reduced. That is, an equivalent source on a large grid is used to model a wavefield by a source near the surface of the water.

Moreover, an equivalent source vector can be easily obtained by multiplying an analytical solution vector by an impedance matrix of a Laplace-domain wave equation, wherein the analytical solution vector is obtained from an analytical solution of a Laplace-domain wave equation in a homogeneous half space by the real source.

Other features and aspects will be apparent from the following detailed description, the drawings, and the claims.

### BRIEF DESCRIPTION OF THE DRAWINGS

FIG. 1 is a diagram illustrating a configuration example of a subsurface structure imaging apparatus.

FIG. 2 is a conceptual diagram for explaining an equivalent source.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

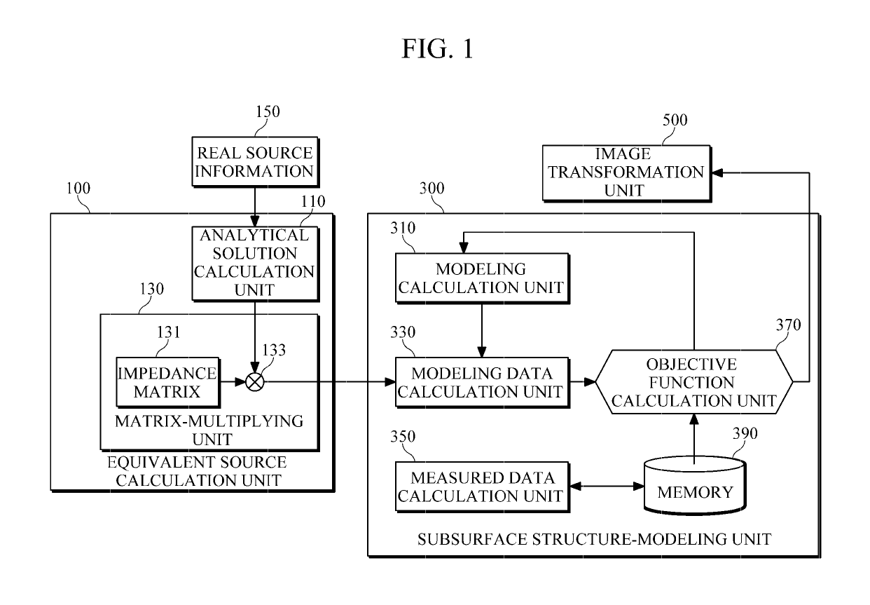

FIG. 1 is a diagram illustrating a configuration example of a subsurface structure imaging apparatus. As illustrated in FIG. 1, the subsurface structure imaging apparatus includes an equivalent source calculation unit 100 for obtaining an equivalent source that is equivalent to a real source and is at least one virtual source located at one of points defining an virtual grid of an area to be measured, and a subsurface modeling unit 300 for obtaining modeling parameter data about a subsurface structure, by performing Laplace-domain waveform inversion on seismic signals acquired by receivers arranged on the virtual grid of the area to be measured, based on a vector of the equivalent source.

In other words, modeling parameter data about a subsurface structure is calculated by obtaining an equivalent source that is equivalent to a real source and is at least one virtual source located at one of points defining an virtual grid of an area to be measured, and then performing Laplace-domain waveform inversion on seismic signals acquired by receivers arranged on the virtual grid of the area to be measured, based on a vector of the equivalent source, instead of performing Laplace-domain waveform inversion using a small grid size based on a real source.

According to an example, the equivalent source is located at one of points defining virtual grids on which receivers are arranged. According to another example, there may be provided a plurality of equivalent sources that are located at points defining virtual grids on which receivers are arranged. That is, the equivalent sources may be defined as equivalent source clusters located at coarse-grid points near the real source. The equivalent source clusters create solutions nearly equivalent to sources located at fine-grid points.

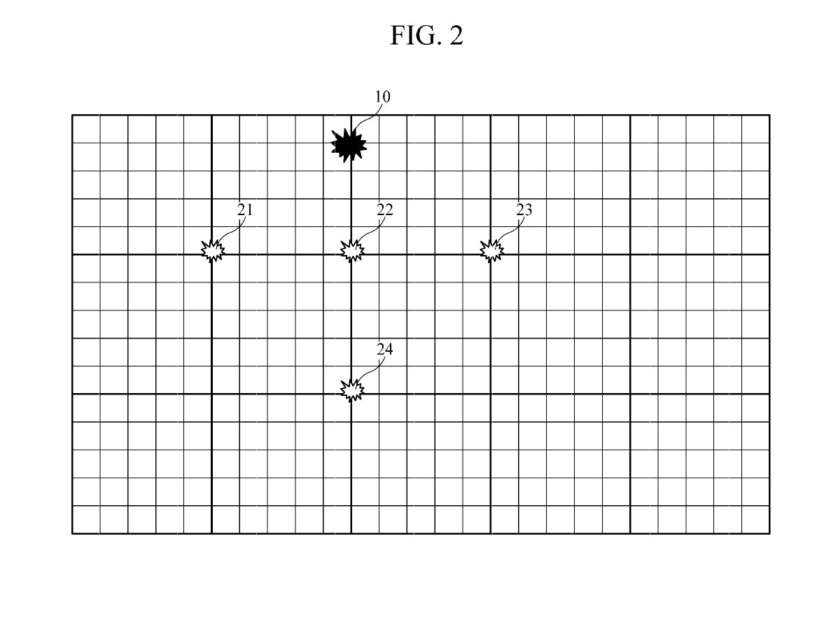

In order to obtain the equivalent sources, it is assumed that there is a combination of sources that create solutions equivalent to original solutions given by performing a finite-element method or a finite-difference method on fine-grid points over the entire domain, and that are to located at points defining large grids. FIG. 2 is a conceptual view for explaining equivalent sources in an example of seismic marine survey. In FIG. 2, a real source 10 is located at a point on the first depth level of the fine grids. An equivalent source cluster is composed of 4 equivalent sources 21, 22, 23, and 24. It is assumed that when the equivalent sources 21, 22, 23 and 24 operate together, the same signals as those received by receivers located at grid points on the surface of the water when the single real source 10 is propagated to the corresponding subsurface structure are received by the receivers. Under the assumption, a method for obtaining equivalent source clusters defined by coarse-grid points is disclosed in this specification.

According to an example, the equivalent source calculation unit 100 includes an analytical solution calculation unit 110 for obtaining an analytical solution vector from an analytical solution of a Laplace-domain wave equation in a homogeneous half space by a real source, and a matrix-multiplying unit 130 for outputting an equivalent source vector by multiplying the analytical solution vector output from the analytical solution calculation unit 110 by an impedance matrix of the Laplace-domain wave equation.

In other words, an equivalent source is obtained by calculating an analytical solution vector by obtaining an analytical solution of a Laplace-domain wave equation in a homogeneous half space by a real source, on a virtual grid defined by arrangement of receivers, and then multiplying the analytical solution vector by an impedance matrix of the Laplace-domain wave equation. This process will be described in more detail below.

A seismic equation in the Laplace domain can be expressed as follows.

$$\frac{{s}^{2}}{{c}^{2}} u = {∇}^{2} u + f , \qquad ( 1 )$$

where s is a Laplace damping constant, c is the propagation rate of the homogeneous half space, u is the wavefield in the Laplace domain, and f is a source function in the Laplace domain. The finite-difference or finite-element method can be used to express equation 1 as a linear algebraic equation below.

Su=f, (2)

where S is an impedance matrix for approximating the differential operator

$$\frac{{s}^{2}}{{c}^{2}} - {∇}^{2} ,$$

u is the wavefield vector in the Laplace domain, and f is a source vector.

The source vector generally approximates a Dirac delta function. Generally, forward modeling means solving a matrix equation to obtain a wavefield vector u when a source vector f is given. The forward modeling is applied backward to obtain a source vector f by multiplying a wavefield vector u by an impedance matrix S when the wavefield vector u is given.

In a seismic equation, a source is located at the first, six-th or seven-th grid point away from the boundary of the surface. A surface boundary condition is given as the Dirichlet boundary condition, that is, the zero pressure condition. In seismic marine survey, an air-gun used as a source is generally located near the surface of the water. Accordingly, adopting coarse-grid points may fail to give a solution suitable for Lloyd mirror effect.

Accordingly, in the current example, by using equivalent sources located at coarse-grid points, a Laplace-domain wave equation can be solved without deteriorating precision. In order to obtain the equivalent sources, a Green's function near a real source is needed. The Green's function of a Laplace-domain wave equation in a homogeneous and unbounded medium is disclosed in Mathematical Methods for Physicists, 6^{th} edition by Arfken, G. B. and Weber, H. J. (Elsevier Academic Press, 2005). Accordingly, the Lloyd mirror effect is used to easily obtain an analytical solution in a homogeneous half space bounded by a free space. The Green's to function can be expressed below.

$$G ( s , {c}_{0} , {r}_{g} , {r}_{s} , {r}_{s}^{′} ) = \frac{{e}^{- \frac{s}{{c}_{0}} \vert {r}_{g} - {r}_{s} \vert}}{4 π \vert {r}_{g} - {r}_{s} \vert} - \frac{{e}^{- \frac{s}{{c}_{0}} \vert {r}_{g} - {r}_{s}^{′} \vert}}{4 π \vert {r}_{g} - {r}_{s}^{′} \vert} , \qquad ( 3 )$$

where c₀ is the propagation velocity rate of waves in the homogeneous half space, r_{g} is a position vector of a receiver, rₛ is a location vector of a real source, and r′ₛ is a location vector of an virtual source according to the Lloyd mirror effect.

Referring to FIG. 1, the analytical solution calculation unit 110 receives location information of a receiver and location information 150 of a real source, and obtains an analytical solution represented by equation (3). A multiplier 133 multiplies the analytical solution by an impedance matrix 131 to obtain an equivalent source, and outputs the equivalent source.

f₀^{equiv}=S₀^{c}u₀^{c} (4)

where f₀^{equiv} is an equivalent source vector in the homogeneous half space, S₀^{c} is an impedance matrix at a coarse-grid point in the homogeneous half space, and u₀^{c} is a wavefield vector sampled at the coarse-grid point from the Green's function expressed by equation (3).

When the grid size approximates 0, the equivalent source f₀^{equiv} converges to a delta function. That is, as the grid size is reduced, a sequence of equivalent sources can be considered as a delta sequence.

The equivalent source is supplied to the subsurface modeling unit 300 for modeling a subsurface structure in the Laplace domain. An apparatus and method for modeling a subsurface structure through waveform inversion in the Laplace domain are disclosed in Korea Patent Application No. 10-2008-0025876.

For subsurface structure survey, a ship, which pulls a streamer with receivers arranged in a grid form, continuously shoots air-guns as sources to measure reflection waves through the receivers. The streamer may be a hydrophone cable filled with floating oil therein. The hydrophone cable includes a piezoelectric receiver that sense changes in pressure. The cable, which is generally composed of 24 through 96 channels, extends in length as necessary.

The measured signal is converted to Laplace-domain data by a measured data processor 350 and then stored in a memory 390. A modeling parameter calculation unit 310 stores initial parameter values about an initial model of the subsurface structure. The initial parameter values may be arbitrarily set. A modeling data calculation unit 330 calculates modeling data that can be detected from individual receiving points when waves generated by equivalent sources are propagated to a subsurface structure defined by modeling parameters. The modeling data may be obtained by solving a wave equation specified by modeling parameters using a numerical analysis method such as a finite-element method or a finite-difference method. An objective function calculation unit 370 obtains an error between the measured data stored in the memory 390 and the modeling data calculated from an arbitrary initial model. The objective function may be selected to a L2 norm, a logarithmic norm, a pth power, and an integral value, etc. When the error is greater than a predetermined value, the modeling parameter calculation unit 310 updates the modeling parameter in the direction of reducing the error. The process is performed by calculating a gradient of an objective function with respect to each model parameter to obtain modeling parameters for minimizing the objective function. The modeling data calculation unit 330 calculates modeling data that can be detected from the individual receiving points when waves generated from the equivalent sources are propagated to a subsurface structure defined by the updated modeling parameters. The objective function calculation unit 370 calculates an error between the measured data stored in the memory 390 and the modeling data calculated from the updated model. When the error is greater than a predetermined value, the modeling parameter is continuously updated, and when the error is smaller than the predetermined value, the corresponding modeling parameter is determined to a final modeling parameter for the subsurface structure and output. The modeling parameter corresponds to a coefficient of a wave equation, and may be a rate, density, etc. of the corresponding subsurface space.

According to an example, the apparatus for imaging the subsurface structure further includes an image transformation unit for color imaging the subsurface structure based on the modeling parameters. The apparatus for imaging the subsurface structure maps velocity or density values to colors with respect to location and outputs a color image.

The above description relates to a method for obtaining equivalent sources for a reference medium, however, the method also may be applied to a heterogeneous space.

f^{equiv}=S^{c}u^{c} (5)

where f^{equiv} is an equivalent source vector in the heterogeneous space, S^{c} is an impedance matrix of a coarse-grid point in the heterogeneous space, and u^{c} is a wavefield vector at a coarse-grid point sampled from a fine-grid point. Since an original real source of a fine-grid point solution is a Dirac delta function whose bandwidth is limited, that is, a sinc function, the equivalent source f^{equiv} can be considered as a kind of delta sequence for approximating the source function. A method of approximating the delta sequence is implicit and dependent to an impedance matrix (that is, the finite-difference method or the finite-element method) and its solution vector. Since a delta sequence at a limiting point converges to the Dirac delta function, the equivalent source converges to the Dirac delta function as the grid size approximates 0.

$${lim}_{Δ \to 0} {f}^{equiv} = {lim}_{Δ \to 0} {S}^{c} {u}^{c} = δ ( r - {r}_{s} ) , \qquad ( 6 )$$

where Δ is the grid size. In the same manner, the equivalent source of the reference medium expressed by equation 4 also converges to the Dirac delta function.

$${lim}_{Δ \to 0} {f}_{0}^{equiv} = {lim}_{Δ \to 0} {S}_{0}^{c} {u}_{0}^{c} = δ ( r - {r}_{s} ) \qquad ( 7 )$$

Accordingly, an equivalent source in a heterogeneous space may be substituted by an equivalent source in a homogeneous space if the grid size is sufficiently small.

The grid size which makes f₀^{equiv} identical to f^{equiv} may be decided through grid dispersion analysis. Generally, as Laplace-domain wave equation modeling has very small grid dispersion compared to time-domain or frequency-domain modeling, a relatively large grid size of about 80 through 220 m, for example, a grid size of 100 m or 200 m can be used. For example, when a grid size of 200 m is used, the amount of calculation can be reduced to ¼⁴= 1/16 compared to the case of using a grid size of 50 m.

As a result, equivalent sources obtained in a homogeneous half space also can be used in a heterogeneous space when large grids of about 80 through 220 m are used. When a grid size is allowed in view of grid dispersion, an equivalent source in the heterogeneous space can approximate equation 8 below.

f^{equiv}≅S₀^{c}u₀^{c}≅f^{equiv} (8)

Velocity near a real source has to be as close to the velocity of the reference model as possible.

Theoretically, the Laplace-domain wave equation modeling also has to be able to be is applied to time-domain or frequency-domain wave equation modeling. However, the above-described approximation is applied neither to the time domain nor to the frequency domain. Since serious numerical grid dispersion occurs in numerical modeling of wave propagation in other domains except for the Laplace domain, it is impossible to use a large grid size of 100 m or more in the other domains. In order to avoid such numerical grid dispersion, a sufficiently small size of grid has to be selected. In this case, since a real source can be defined at a finite-difference or finite-element node point and results in a sinc function source, the method of using equivalent sources does not need to be used. Accordingly, the method of using equivalent sources can be effectively used in non-dispersive or small-dispersive numerical modeling such as Laplace-domain wave equation modeling.

In order to test the present invention to solve a non-homogeneous complex velocity problem, a SEG/EAGE 3D salt model is selected to create a velocity model sampled at a point of a large grid, an equivalent source according to the present invention is calculated, and then Laplace-domain wave inversion is applied to obtain a solution. Then, the solution is compared to a Laplace-domain Kaiser windowed sinc function method. First, a solution for fine grids is calculated using a source at the depth of 50 m and a grid size of 50 m. The solution is assumed to be a correct solution. Then, the grid size is set to 200 m and a solution is obtained using the equivalent source. The solution obtained using the equivalent source is nearly identical to the solution obtained when the grid size of 50 m is used. Results obtained using the Kaiser windowed sinc function method when the half-width of a window is set to 10 and a maximum wavenumber of interest is set to π/2 show serious distortion near the source compared to the correct solution.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An apparatus for imaging a subsurface structure, comprising:
an equivalent source calculation unit to obtain an equivalent source that is equivalent to a real source, wherein the equivalent source is at least one virtual source located at one of points defining virtual grids in an area to be measured; and
a subsurface structure-modeling unit to obtain modeling parameter data about the subsurface structure, by performing Laplace-domain waveform inversion on a plurality of seismic signals acquired by a plurality of receivers arranged on the virtual grids in the area to be measured, based on a vector of the equivalent source.

2. The apparatus of claim 1, wherein the equivalent source calculation unit comprises:
an analytical solution calculation unit to obtain an analytical solution vector from an analytical solution of a Laplace-domain wave equation in a homogeneous half space by a real source; and
a matrix-multiplying unit to obtain the vector of the equivalent source by multiplying the analytical solution vector by an impedance matrix of the Laplace-domain wave equation.

3. The apparatus of claim 1, wherein the equivalent source is located at one of points defining virtual grids on which the receivers are arranged.

4. The apparatus of claim 1, further comprising an image transformation unit to color image the subsurface structure using the modeling parameter data.

5. The apparatus of claim 1, wherein a plurality of equivalent sources are located at points defining virtual grids on which the receivers are arranged.

6. A method for imaging a subsurface structure, comprising:
obtaining an equivalent source that is equivalent to a real source, wherein the equivalent source is at least one virtual source located at one of points defining virtual grids in an area to be measured; and
obtaining modeling parameter data about the subsurface structure, by performing Laplace-domain waveform inversion on a plurality of seismic signals acquired by a plurality of receivers arranged on the virtual grids in the area to be measured, based on a vector of the equivalent source.

7. The method of claim 6, comprising:
obtaining an analytical solution vector by obtaining an analytical solution of a Laplace-domain wave equation in a homogeneous half space by a real source, on a virtual grid defined by arrangement of the receivers; and
obtaining the vector of the equivalent source by multiplying the analytical solution vector by an impedance matrix of the Laplace-domain wave equation.

8. The method of claim 6, further comprising color imaging the subsurface structure from the modeling parameter.

9. The method of claim 6, wherein the analytical solution vector is given by:
$$\frac{{e}^{- \frac{s}{{c}_{0}} \vert {r}_{g} - {r}_{s} \vert}}{4 π \vert {r}_{g} - {r}_{s} \vert} - \frac{{e}^{- \frac{s}{{c}_{0}} \vert {r}_{g} - {r}_{s}^{′} \vert}}{4 π \vert {r}_{g} - {r}_{s}^{′} \vert}$$
where c₀ is a propagation velocity of a wave in the homogeneous half space, r_{g} is a position vector of a receiver, rₛ is a location vector of the real source, and r′ₛ is a location vector of the virtual source according to a Lloyd mirror effect.

10. A recording medium storing a program by which the method of claim 6 is implemented.

11. A subsurface structure imaging apparatus for modeling a subsurface structure with respect to a grid having a size of 80 through 220 m, using data obtained by measuring a wavefield emitted from a source at a depth of 5 through 20 m from the surface of the water through a streamer.
